(19) United States
(12) Patent Application Publication
(10) Pub. No.: US 2011/0000270 A1
(43) Pub. Date: Jan. 6, 2011

(54) Organic slurry compositions and method of application

(75) Inventor: David H. Disbrow, Coral Springs, FL (US)

Correspondence Address: ROBERT M. DOWNEY, P.A., 6751 N. FEDERAL HWY., SUITE 300, BOCA RATON, FL, 33487, US

(73) Assignee: Organic Green Solutions, Inc.

(21) Appl. No.: 12/803,069

(22) Filed: Jun. 18, 2010

Related U.S. Application Data
(60) Provisional application No. 61/269,051, filed on Jun. 18, 2009.

(51) Int. Cl. C05F 11/00

(52) U.S. Cl. 71/23

(57) ABSTRACT

A system and method for amending existing soil to conserve water and fertilizer utilizes the application of a slurry comprised of phytosanitary certified organics and water. The method includes mechanically mixing a variety of organic materials into slurry which may be applied to a prepared section of land using a conventional pump, hose and nozzle or other types of commercially available spraying equipment. The composition of the slurry is specifically formulated for supplying nutrients and water while improving the water and fertilizer holding capabilities of the existing soil by homogenizing with the soil. The slurry comprises entirely organic ingredients which are selectively and custom blended with various nutrients, organic pesticides and/or organic herbicides to accommodate specific needs of agricultural products, horticultural species, grasses or other plant life being grown in the soil. The entirely organic composition of the slurry makes application safe for plant, human and animal life immediately after application and helps reduce and remove the pollution caused by application of synthetic fertilizers and harmful chemicals through bioremediation.

This non-provisional patent application is based on provisional patent application Ser. No. 61/269,051 filed on Jun. 18, 2009.

### BACKGROUND OF THE INVENTION

1. Field of the Invention

The present invention relates to amending existing soil using fertilizer application techniques and, more particularly, to application of entirely organic slurry comprised of water and phytosanitary organics to add nutrients and improve the water and fertilizer retention of the amended soil.

2. Discussion of the Related Art

Plant life existing in concentrated areas of human population does not always have access to the nutrients otherwise provided by nature. Because of this, nutrients, fertilizers, pesticides and other solutions are often applied to the soil of said plant life. Currently, the majority of applied fertilizers and solutions are man-made and comprised substantially of chemicals not found in natural soil. These chemicals are considered harmful because of their negative effects on the health of humans and local animal life. Moreover, the detrimental impact that chemicals have on the environment, including the water supply, is of particular concern. Additionally; application of harmful chemicals can permanently damage the soil, making it toxic for animal life and reducing the levels of nutrients which it provides. Interactions between plant life and animal life such as the interaction between flowers and insects (e.g. bees) are an essential function of nature to ensure the survival of both the animal and plant life. Chemicals which ward off insects and other animal life accordingly reduce the health and natural function of the plant life.

In view of the shortcomings associated with the currently used chemical fertilizers, herbicides and pesticides applied to lawns and plant life, there remains a need for an entirely organic composition which is safe for plant life, humans and animal life and which provides custom blended nutrients for specific plant life, agricultural products and grasses while also providing soil amendment and bioremediation benefits.

### OBJECTS AND ADVANTAGES OF THE INVENTION

Considering the foregoing, it is a primary object of the present invention to provide a system and method for amending existing soil by applying a unique combination of phytosanitary certified organics and organic micronutrients for the purpose of significantly improving the water and nutrient holding ability of the soil and thereby conserving water while providing superior, custom blended organic nutrients to specific plant life.

It is a further object of the present invention to provide a system and method for amending existing soil, as detailed above, which provides excellent microbial fertility, thereby improving the environment that the plants need for healthy development.

It is still a further object of the present invention to provide a system and method for amending existing soil, as detailed above, which will not harm any animal life or humans that interact with the affected plant life.

It is still a further object of the present invention to provide a system and method for amending existing soil, as detailed above, which will re-establish the natural balance in the composition of the soil through bioremediation, thereby helping to rid the soil of pollutants and toxins caused by harmful chemically-based fertilizers, herbicides and pesticides that previously applied to the soil.

It is still a further object of the present invention to provide a system and method for amending existing soil, as detailed above, which will encourage rapid root growth and help hold moisture for developing roots.

It is still a further object of the present invention to provide a system and method for amending existing soil, as detailed above, which is suitable for both outdoor application and indoor application such as in hotels, shopping malls etc.

It is still a further object of the present invention to provide a system and method for amending existing soil, as detailed above, which can be supplemented with organic pre-emergence for weed control.

It is still a further object of the present invention to provide a system and method for amending existing soil, as detailed above, which adds entirely all natural, organic nutrients to the soil.

It is still a further object of the present invention to provide a system and method for amending existing soil, as detailed above, which can be custom blended with a variety of nutrients and seeds during application.

It is still a further object of the present invention to provide a system and method for amending existing soil, as detailed above, which can be applied using a conventional pump, hose and nozzle or other types of commercially available spraying equipment.

### SUMMARY OF THE INVENTION

The present invention is directed to a system and method for amending existing soil with phytosanitary certified organics to conserve water while introducing organic nutrient formulations to the soil that are custom blended with the optimal nutrients for specific plant life including, but not limited to grass varieties, horticultural varieties and agricultural products. The process of the invention includes the mechanical mixing of a variety of organic matter into a slurry intended for application onto existing soil through a spraying or pumping method. This unique blend of entirely organic components is specifically designed for homogenizing with the amended soil. The slurry is designed to deliver the custom blend of natural nutrients to the plant, while simultaneously slowing the sinking of water and nutrients through the soil by holding the water and nutrients near the root level. In doing so, the soil amendment gives the affected plant life and soil greater and prolonged exposure to the applied nutrients and water.

The organic slurry is specifically engineered to be safe for all plant life, animal life and humans, and presents no health risks, even with direct exposure. Accordingly, plant and animal life which rely on interaction with each other will be able to do so without negative affect from the fertilizer. Moreover, sports fields can be used immediately after application of the slurry, thereby avoiding down time that is typical after chemical treatment of grass fields.

The composition of the slurry is designed to provide excellent microbial fertility for the healthy development of plant life. A number of the components act as a fast acting organic nutrient delivery system which provides a slow, natural release to the affected plant life. Other components of the slurry encourage rapid root growth and help hold in the surrounding moisture for developing roots. The slurry may be supplemented with organic pre-emergence for weed control. A variety of seeds may be added to the tank and applied at the same time as the fertilizer. All of the components of the slurry help to prevent the necessity for harmful chemical applications and eliminate the harmful runoff of pollutants. The blend as an entirety has a neutral pH which assures that the affected plant life will fully absorb the provided nutrients.

The slurry is applied using a conventional pump, hose and nozzle or other types of commercially available spraying equipment. The blend of organic materials is mixed with clean water from a local water source before application. Indoor application is fully contemplated and is not limited in any way by the composition of the applied slurry.

### BRIEF DESCRIPTION OF THE DRAWINGS

For a fuller understanding of the nature of the present invention, reference should be made to the following detailed description taken in conjunction with the accompanying drawings in which:

FIG. 1 shows the differences in humic acid content of various organic materials;

FIG. 2 shows the differences in cation exchange capacity of various organic materials;

FIG. 3 shows the differences in carbon to nitrogen ratio of various organic materials; and

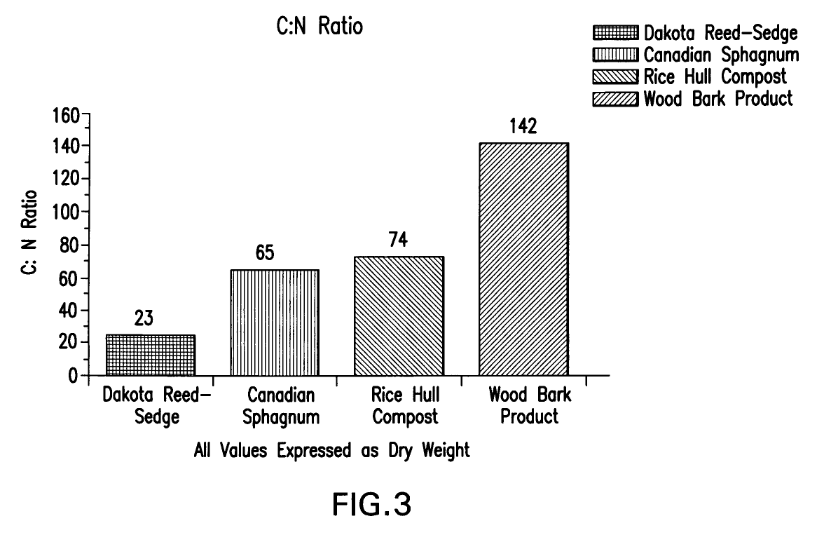

FIG. 4 is a schematic diagram illustrating a machine for mixing, pumping and applying the organic slurry.

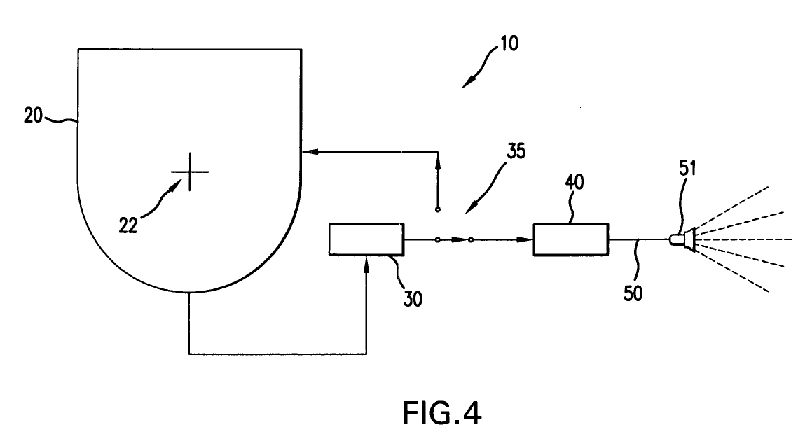

### DETAILED DESCRIPTION OF THE PREFERRED EMBODIMENTS

Numbers in the present disclosure are rounded to the nearest significant figure using conventional rounding techniques. Ranges of numbers contained herein are understood to contain the numbers on the upper and lower limits, unless otherwise indicated. For instance, a range “from 1 to 10” is understood to include a range including the number “1,” and up to and including the number “10.”

Decayed, compacted Sphagnum moss has the name of peat or peat moss. Peat moss is typically used as a soil conditioner which increases the soil's capacity to hold water and nutrients by increasing capillary forces and cation exchange capacity (CEC). This is often necessary when dealing with very sandy soil, or plants that need an increased moisture content to flourish.

It should be noted that there is a difference in naming conventions for similar things related to sphagnum moss. The terms that people use when referring to moss peat, peat moss, and bog moss can be taken out of context and be used when reference is actually being made about a plant that is still growing, as opposed to the decayed and compressed plant material. These terms are commonly used for both forms of the same plant material, resulting in confusion as to what the speaker is actually talking about. In addition, the term “peat moss” is used to describe materials that are not sphagnum moss. As used herein, the term “peat moss” will refer to decayed, compacted sphagnum moss.

The starting material used as the base component of the organic slurry compositions used in the soil amendment according to the present invention is Dakota Reed-Sedge. One skilled in the art would readily know this material commonly used by horticulturists, among others. This material is readily available, for example, from Dakota, Inc., Grand Forks, N. Dak. 58201.

Dakota Reed-Sedge is not technically peat moss. Dakota peat is not decaying sphagnum moss. Dakota peat is formed principally from partially decomposed reeds, sedges, marsh grasses and other associated plants. As used herein, this material is referred to as “dakota reed-sedge” or “dakota peat.”

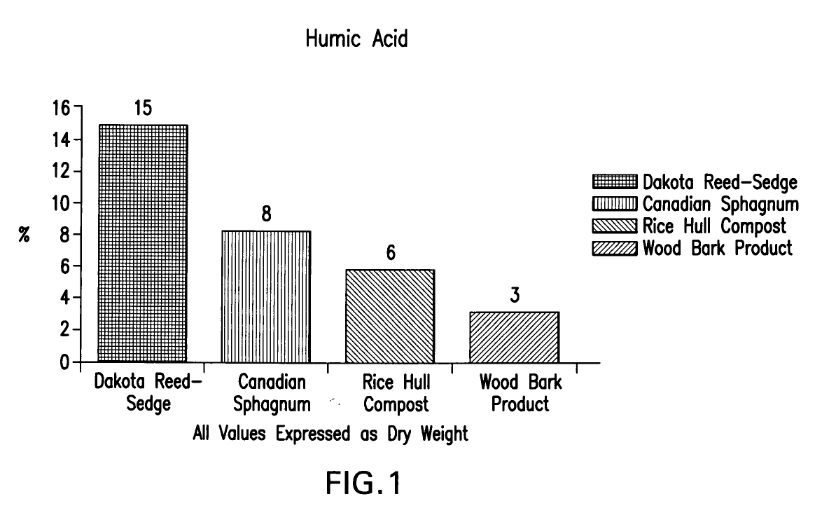

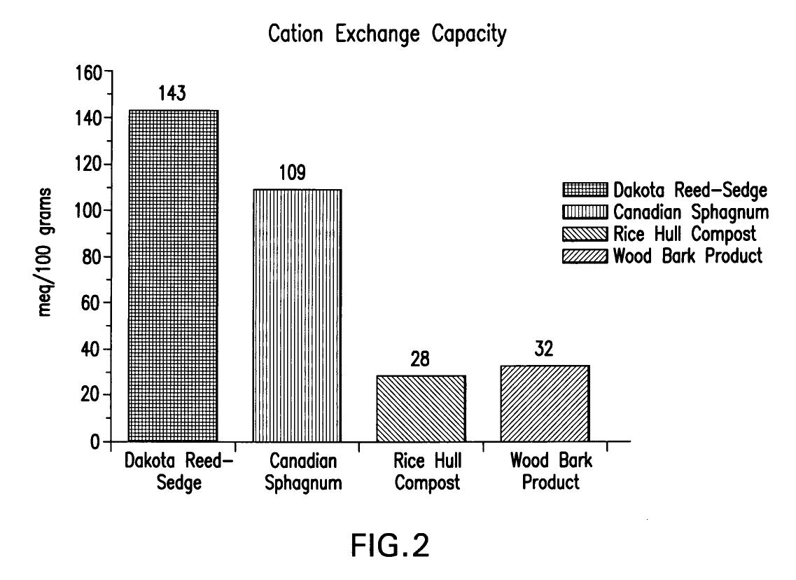

Typically, Dakota peat is found where pre-existing glaciers had covered reeds and sedges under great pressure for a long period of time, possibly many thousands of years. These conditions allow the reeds and sedges to degrade to form a unique composition with some properties superior to conventional peat moss. One example of this is shown in FIG. 1. FIG. 1 shows the results of a test analyzing the amount of humic acid in various types of compost. The amount of humic acid present may be a relative index of the state of decomposition. Humic acid may enhance the aggregation of soil materials and promote soil structure. Dakota peat had a much higher percentage of humic acid than traditional peat moss. Similar results may be seen from the measurement of cation exchange capacity shown in FIG. 2, and carbon to nitrogen ratio, shown in Table 3.

Dakota peat is found in deposits in nature. Where a pocket of Dakota peat exists, it may be collected in its pure form by mining, scooping, or other gathering means. Dakota peat has certain physical characteristics that may be measured. Typically, Dakota peat has a total carbon content of greater than about 45% and up to 60%, a carbon to nitrogen ratio of from about 15:1 to about 23:1, a pH of from about 6.0 to about 7.0. The Dakota peat may also have a humic acid content of greater than about 15%, and a fulvic acid content of greater than about 10%. In order to sieve the product for use, one embodiment may have a passing % of from about 95% to about 100% through a 2.0 mm sieve. In another embodiment, the Dakota peat may have a passing % of greater than about 80% through a 1.0 mm sieve. In another embodiment, the Dakota peat may have the characteristics contained in Table 1.

TABLE 1

| | Soluble | | | | | |
|---|---|---|---|---|---|---|
| pH | Salts | CEC | Nitrate N | Ammonical N | P-Olsen | K |
| 6.5 | 0.52 mmhos/cm | 19.3 | 92 ppm | 5.3 ppm | 4 ppm | 10 ppm |
| | | meg/100 g | | | | |
| Ca | Mg | Na | Sulfate S | Zn | Fe | Mn |
| 2997 ppm | 511 ppm | 16 ppm | 60+ ppm | 0.8 ppm | 34.8 ppm | 2.6 ppm |
| Cu | B | Cl | OM | Organic C | TKN | C:N ratio |
| 0.12 ppm | 0.55 ppm | 25 ppm | 84.85% | 45.50% | 2.63% | 17.01 |

In certain other embodiments, the Dakota peat may have the characteristics contained in Table 1 +/− about 1%. In further embodiments, the Dakota peat may have the characteristics contained in Table 1 +/− about 5%. In still further embodiments, the Dakota peat may have the characteristics contained in Table 1 +/− about 10%.

In another embodiment, the Dakota peat may have the characteristics contained in Table 2, which compares Dakota peat to other materials.

TABLE 2

| | Ideal Material | DAKOTA | Sphagnum Peat | Biosolids |
|---|---|---|---|---|
| Base Source Material | Highly | Highly | Forest Woods | Human, Animal, |
| | Decomposed | Decomposed | | yard and |
| | | Reed Sedges | | industrial waste |
| pH | Neutral | Neutral | Low | Not Stable |
| Carbon to Nitrogen Ratio | 15/1 | 15/1 to 23/1 | 25/1 to 65/1 | Not Stable |
| Nutrient Release | Yes | Yes | Nutrient Users | Not Stable |
| Nutrient Holding Capacity (CEC) | >125 | 125-140 | 100-200 | 80 |
| Stored Water Release before Wilt | Yes | Yes | Not Stable | Not Stable |
| Rehydrate Ability | Excellent | Excellent | Very Poor | Very Poor |
| Decomposition Rate | Slow | Slow | Medium to Fast | Fast |
| Phytosanitary Status | Excellent | Excellent | Poor | Poor |
| Microbial Fertility | Excellent | Excellent | Very Poor | Poor |
| Organic Content by Volume | High | High | Low | Moderate |
| Chance of Layering | Low | Very Low | High | High |
| Mixing Ability | Homogenous | Homogenous | Segregated | Not Consistent |
| Hazardous Risk | Low | Very Low | Low | High |

In certain other embodiments, the Dakota peat may have the characteristics contained in Table 2 +/− about 1%. In further embodiments, the Dakota peat may have the characteristics contained in Table 2 +/− about 5%. In still further embodiments, the Dakota peat may have the characteristics contained in Table 2 +/− about 10%.
These starting materials may be available in a pre-ground particulate biomass form. If necessary, the starting materials can be ground up and sieved to obtain particulate biomass exhibiting a particular particle-size distribution. In one embodiment, the median diameter of the particles is 85.1680 μm as determined by a laser light scattering analyzer. In another embodiment, the mean diameter of the particles of dakota reed-sedge is 93.8941 μm as determined by a laser light scattering analyzer. The average particle size can be controlled by selection of a suitable screen sizes known in the art. The particle size is not limited to any specific size so long as the minimum and maximum particle sizes fall within the particle distribution range.

In certain embodiments, the particulate biomass has a passing % of from about 95% to about 100% through a 2 mm sieve. In other embodiments, the particulate biomass has a passing % of greater than 80% to through a 1 mm sieve. In further embodiments, the particulate biomass of Dakota Reed-Sedge has a median particle size of 85.1680 μm. In still other embodiments, the particulate biomass of Dakota Reed-Sedge has a mean particle size of 93.8941 μm.

In certain embodiments, the particulate biomass has a carbon to nitrogen ratio of from about 15:1 to about 23:1. In other embodiments, the particulate biomass has a pH of from about 6.0 to about 7.0. In further embodiments, the particulate biomass has a humic acid content of greater than about 15%, and a fulvic acid content of greater than about 10%.

In certain embodiments, the particulate biomass has a cation exchange capacity of 143 meq/100 grams. In other embodiments, the particulate biomass has humic acid content of about 15%. In further embodiments, the particulate biomass has carbon to nitrogen ratio range from 15:1 to 23:1. In still further embodiments, the particulate biomass has a pH from about 6.5-7.0.

Certain embodiments of the present disclosure include a method of remediating water immiscible hydrocarbons and other toxins from contaminated soil, the method comprising contacting the soil with an amount of particulate biomass of Dakota Reed-Sedge for a period sufficient for the particulate biomass to encapsulate said hydrocarbons; and allowing the biomass with absorbed or adsorbed hydrocarbons and/or other toxins to remain in the soil until decomposition by soil micro and macro flora.

The particulate biomass of Dakota Reed-Sedge is mechanically mixed with a custom blend of organic nutrients specifically formulated for a particular plant, grass or agricultural species to produce an organic mix. This organic mix is used to produce the organic slurry that is applied to soil areas to provide a soil amendment having the beneficial nutrient and bioremediation properties.

In the preferred embodiment, the device 10 for mixing, pumping and applying the organic slurry is comprised of a tank 20, a pump 30, a strainer 40, and a hose 50. Organic mix is added to tank 20 along with water. The tank 20 contains motorized paddles 22 for mixing the organic slurry. After mixing, the slurry is transported using the power of pump 30. The slurry reaches strainer 40 where any pieces too large to fit through the hose nozzle 51 are filtered. The slurry travels through hose 50 and exits out of hose nozzle 51 for application.

Bypass valve 35 is pressure activated when hose nozzle 51 is closed. In this way, when hose nozzle 51 is closed, the slurry undergoes a circuit between the tank 20 and the pump 30 which adds additional mixing and helps keep the materials in a suspension in tank 20, thereby making sure that organic material is evenly distributed throughout the slurry.

Specific mixtures comprising the organic slurry may differ based on the target plant life or based on the intended effect. A standard lawn care blend comprises 0.25 lbs per gal. of water of Soil Amendment (contains organic carbon, neutral pH) and 0.5 lbs per gal. of water of Organic Nutrient Blend (contains pasteurized poultry manure).

An over seed blend comprises 0.25 lbs per gal. of water of Soil Amendment (contains organic carbon, neutral pH), 0.5 lbs per gal. of water of Organic Nutrient Blend (contains pasteurized poultry manure), any varieties of grass seeds in an amount of approximately 50 lbs per 500 gal. of water.

A pre-emergence blend for weed control can be created using either formula above or other formulas, and by adding 0.25 lbs of Corn Gluten per gal. of water.

While the present invention has been shown in accordance with several preferred and practical embodiments, it is recognized that departures from the instant disclosure are fully contemplated within the spirit and scope of the present invention.

What is claimed is:

1. A slurry composition for amending soil to support growth of one or more species of plant life comprising:
a particulate biomass having a total carbon content of greater than 45%, a carbon to nitrogen ratio of between 15:1 to 23:1, a pH of between 6.0 and 7.0, a humic acid content greater than 15%, and a fulvic acid content greater than 10%;
a custom blend of organic nutrients for the particular plant species; and
water.

2. The slurry composition as recited in claim 1 wherein the particulate biomass is Dakota Reed-Sedge.

3. A method of producing an organic slurry composition comprising the steps of:
grinding decomposed reeds, sedges, marsh grasses and plants to produce a particulate biomass having a total carbon content greater than 54%, a carbon to nitrogen ratio of between 15:1 and 23:1, a pH of between 6.0 and 7.0, a humic acid content greater than 15% and a fulvic acid content greater than 10%;
formulating an organic nutrient custom blend for a specific one or more species of plant life;
combining the particulate biomass and the organic nutrient custom blend to produce an organic mix; and
adding water to the organic mix and mixing to produce the organic slurry.

4. The method as recited in claim 3 wherein the decomposed reeds, sedges, marsh grasses and plants is Dakota Reed-Sedge.
